(19) United States
(12) Patent Application Publication
(10) Pub. No.: US 2021/0008509 A1
(43) Pub. Date: Jan. 14, 2021

(54) PARALLEL PRODUCTION OF EMULSIFICATION

(71) Applicant: Imagine TF, LLC, Campbell, CA (US)

(72) Inventor: Brian Edward Richardson, Los Gatos, CA (US)

(21) Appl. No.: 16/923,940

(22) Filed: Jul. 8, 2020

Related U.S. Application Data
(60) Provisional application No. 62/921,823, filed on Jul. 9, 2019.

(51) Int. Cl. B01F 3/08

(52) U.S. Cl. CPC B01F 3/0807; B01F 13/0062

(57) ABSTRACT

An emulsification device with plenums to supply and extract fluids from a large number of emulsification junctions is disclosed herein. The plenums deliver fluid to and extract emulsifications from emulsification junctions and their related channels at nearly identical pressures. The emulsification junction and the related channels share nearly identical geometry. By providing nearly identical pressure and geometry of the features, the flow at each of the emulsification junctions is also nearly identical. This allows for the production of nearly identically sized droplets. The consistency of the dimensions of the emulsification areas contributes to consistent sized droplet formation.

### CROSS REFERENCE TO RELATED APPLICATIONS

This application claims priority of U.S. Provisional Application No. 62/921,823, filed Jul. 9, 2019. The disclosure of that application is incorporated herein by reference in its entirety.

### FIELD OF THE PRESENT DISCLOSURE

The present disclosure is for a device used in emulsification processes. More specifically, the device allows for the parallel arrangement of emulsification junctions which allows for the supply and extraction of fluids to and from the emulsification junctions at near identical pressures.

### SUMMARY

Various embodiments of the present disclosure teach a device generally constructed from three plates, and used for the production of emulsions. The first plate, a micro fluidic plate, includes an array of identical micro fluidic channels for the creation of emulsifications in a parallel configuration. The channels connect to plenums that allow fluids to flow into and out of the emulsification micro fluidic channels at equal pressures. The second plate, a manifold plate, mates to the micro plate and distributes fluids from the inlet and outlet ports to the plenums. The distribution occurs on both sides of the manifold plate and utilizes feedthrough holes. The micro channels and the plenums are created by features on the micro fluidic plate and the manifold plate.

Emulsification junctions and their related channels are near identical in size and configuration. This arrangement allows for the creation of large quantities of emulsifications that are generated under identical conditions. The reproducibility of the conditions allows for the production of nearly identically sized droplets. The use of semiconductor processing equipment provides incredible accuracy as well as the ability to construct extremely small features.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of an emulsification device with a cover plate and a micro fluid plate.

FIG. 2 is a perspective view of the emulsification device shown in FIG. 1 with the cover plate removed.

FIG. 3 is a closeup perspective view illustrating a portion of the manifold plate.

FIG. 4 is a bottom perspective view of the manifold plate.

FIG. 5 is a top perspective view of the micro fluidic plate.

FIG. 6 is a closeup view of the micro fluidic plate.

FIG. 7 is a closer perspective view of the micro fluidic plate shown in FIG. 6.

FIG. 8 is a top view of the micro fluidic plate section shown in FIG. 7.

FIG. 9 is a top perspective view of an alternate embodiment of the emulsification device utilizing a double manifold plate.

FIG. 10 is a bottom perspective view of the double manifold plate.

FIG. 11 is a top view of the double micro fluidic plate employed in the embodiment illustrated in FIG. 9.

FIG. 12 is a closeup view of the double micro fluidic plate illustrated in FIG. 11.

FIG. 13 is a top view of the double micro fluidic plate shown in FIG. 12.

FIG. 14 is a second alternate embodiment of the micro fluidic plate shown in FIG. 13.

FIG. 15 shows a number of micro fluidic plates stacked on top of one another to increase system capacity.

FIG. 16 shows a third alternate embodiment of the emulsification channels.

FIG. 17 shows a fourth alternate embodiment of the emulsification channels.

FIG. 18 shows a fifth alternate embodiment of the emulsification channel location.

FIG. 19 shows a sixth alternate embodiment of the emulsification device.

### DETAILED DESCRIPTION

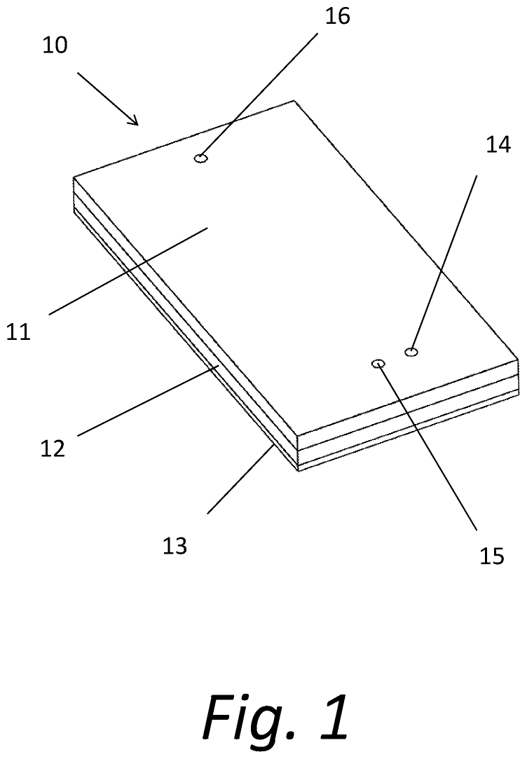

FIG. 1 is a perspective view of an emulsification device 10. The emulsification device 10 is constructed with a plurality of plates. The plurality of plates includes at least a cover plate 11, a manifold plate 12, and a micro fluidic plate 13. The cover plate 11 has at least three fluid ports: a fluid one inlet port 14, a fluid two inlet port 15, and an outlet port 16. Fluid one inlet port 14 provides an inlet for a first fluid to be used in the emulsification process. Fluid two inlet port 15 provides an inlet for a second fluid. Outlet port 16 allows a resultant emulsification product to be output from the emulsification device 10. The ports 14, 15, 16 are through holes in the cover plate 11 that are in fluid communication with the manifold plate 12. A bottom side of the cover plate 11 is flat and mates to a top surface of the manifold plate 12. The first and second fluids are the fluids that are used to create the emulsification product that is output at the outlet port 15. Fluids one and two are immiscible.

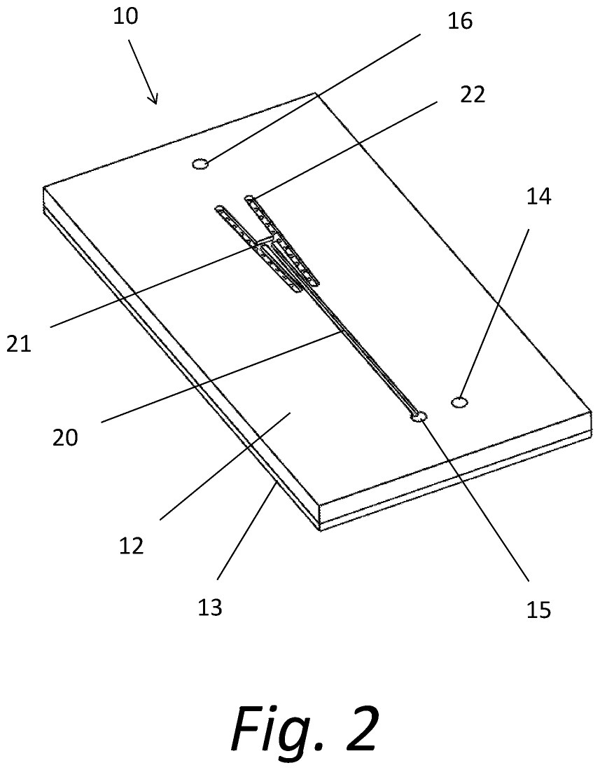

Referring now to FIG. 2, the emulsification device 10 is shown with the cover plate 11 removed to show the fluid one inlet port 14 and the fluid two inlet port 15 on the manifold plate 12. The fluid one inlet port 14 receives the first fluid after it passes through the cover plate 11 and delivers the first fluid to a top side of the manifold plate 12. Fluid two inlet port 15 receives the second fluid after it passes through the cover plate 11. The fluid two inlet port 15 is shown as a through hole. In some embodiments, the through hole serves no purpose, and could just as easily be a counterbore. In various other embodiments, discussed in greater detail below, the fluid two inlet port 15 is required to be a through hole to allow fluid to pass through the manifold plate 12.

In some preferred embodiments, the fluid two inlet port 15 supplies fluid two to a fluid two channel 20. The fluid two channel 20 is in fluid communication with a cross channel 21, and then with a fluid two plenum 22. The channels 20, 21 and the fluid two plenum 22 in the manifold plate 12 are bounded on three sides by the manifold plate 12. The open sides of the channels 20, 21 and the plenum 22 are closed with the cover plate 11. In the embodiment illustrated in FIG. 2, multiple fluid two plenums 22 are shown. Multiple plenums 22 allow for greater capacity in the device 10. In applications where capacity is not important, only one fluid two plenum 22 might be deployed. In this case the cross channel 21 would not be required. The fluid two channel 20 would deliver fluid to the fluid two plenum 22 directly.

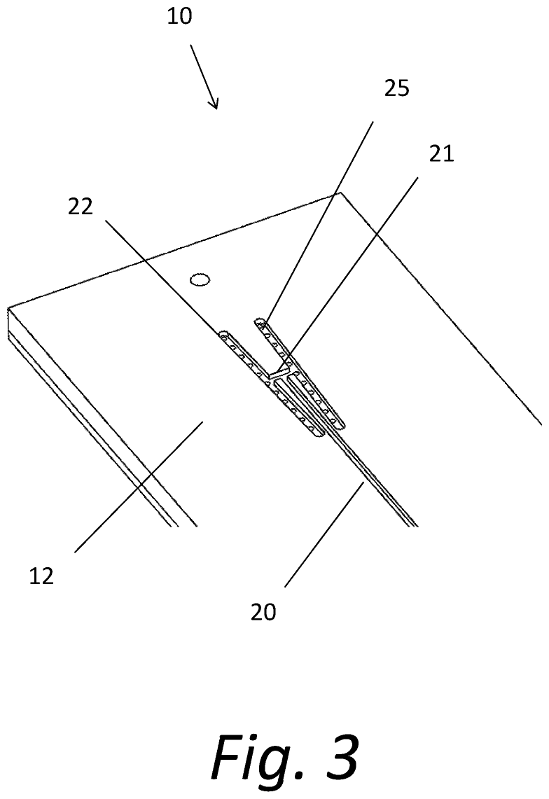

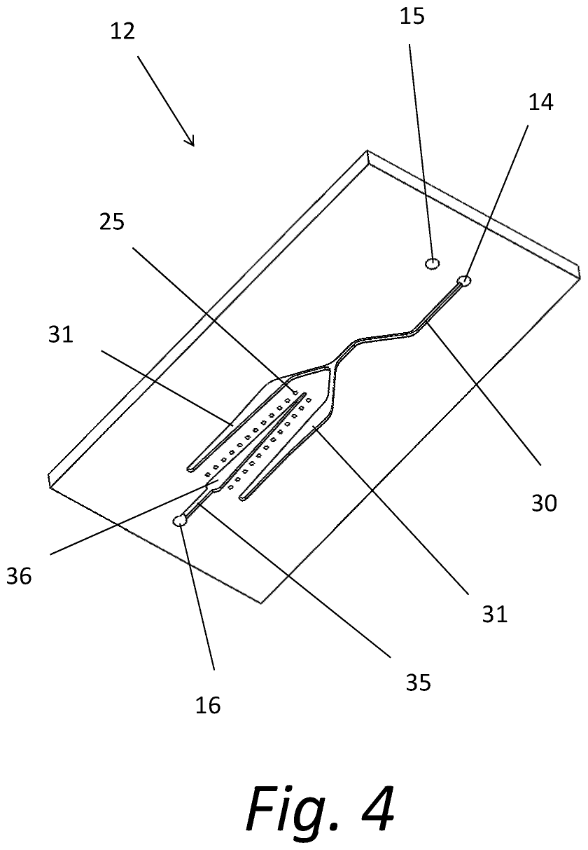

The details of the plenums 22 are more readily observed in the closeup view shown in FIG. 3. In FIG. 3 feedthrough holes 25 are supplied by the plenum 22 at generally a uniform pressure. The size (width and depth) of the plenum 22 is engineered to ensure that the particular fluid and fluid flow rate are delivered to the feedthrough holes 25 within a pressure range suitable for the desired emulsification process. The feedthrough holes 25 deliver fluid two to the bottom side of the manifold plate 12, which can be readily viewed in FIG. 4. A preferred manufacturing method for the manifold plate 12 is injection molding. Alternate, more expensive, methods of manufacturing for the manifold plate 12 are semiconductor processing or machining. Smaller feedthrough holes 25 are obtainable with semiconductor processing than can be readily had with injection molding. The choice of materials and processing methods depends generally on the type of fluids used in the process and the size of the particles the emulsification process produces.

On an underside of the manifold plate 12, the fluid one inlet port 14 is connected to a fluid one channel 30. The fluid one channel 30 delivers fluid from the fluid one inlet port 14 to the fluid one plenum 31. In the embodiment illustrated in FIG. 4, two fluid one plenums 31 outboard of the fluid two feedthrough holes 25 are shown in alignment with the duplicate topside plenums and feedthroughs. As mentioned above, any number of sets of plenums and feedthroughs could be deployed to meet the requirements of a given process.

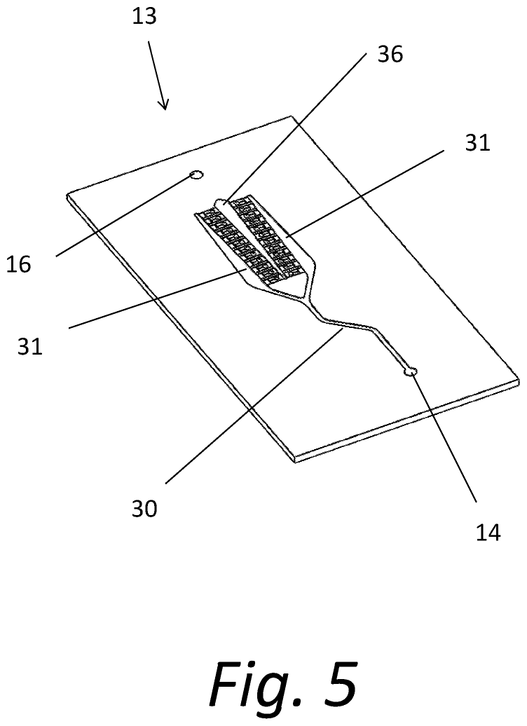

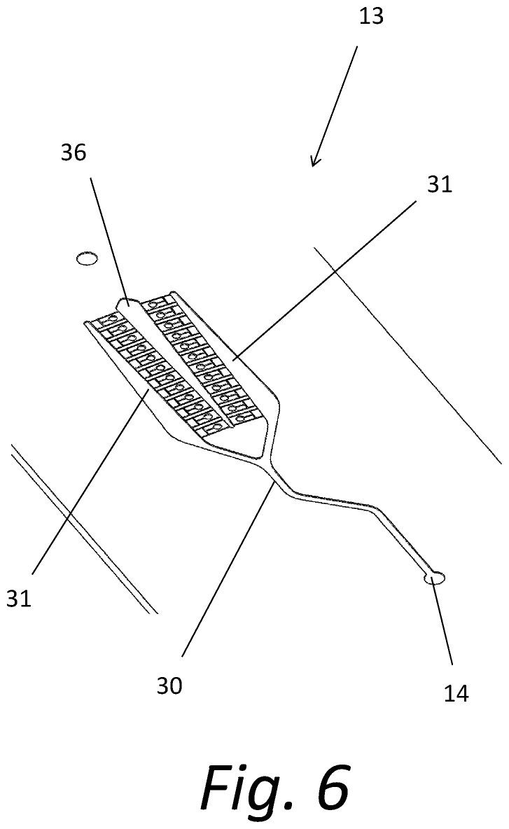

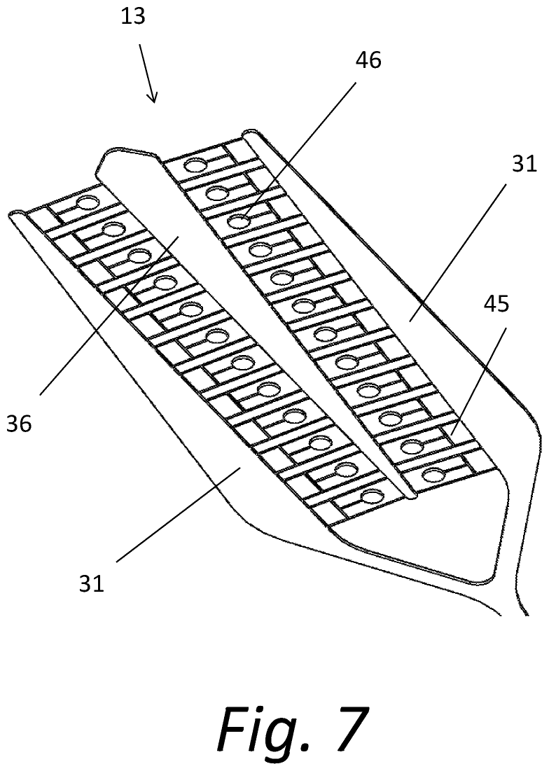

Between the feedthrough holes 25 and the plenums 31 an outlet plenum 36 is positioned. The outlet plenum 36 is connected to an outlet port 16. The plenums and feedthrough holes are in fluid communication with one another via features on the top side of the micro fluidic plate 13. The top side of the micro fluidic plate 13 can be readily seen in FIGS. 5, 6, 7 and 8.

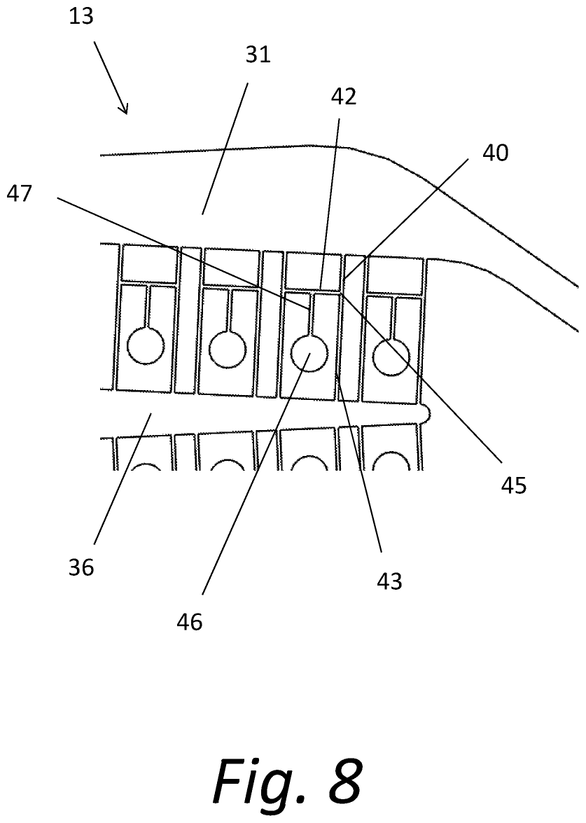

The fluid flow features can perhaps be most readily understood by referring first to FIG. 8. Fluids in the fluid one plenum 31 feed the micro one channels 40. It should be noted that the fluid on plenum 31 on the micro fluidic plate 13 has the same configuration as the fluid one plenum 31 on the manifold plate 12. It should also be noted the plenum 31 does not need to extend to both the manifold plate 12 and the micro fluidic plate 13. Only one location is required. By definition plenums are configured with a relatively large volume to deliver fluids to various locations at generally the same pressure. The disclosed plenums are longer, wider, and deeper than their associated channels.

As mentioned above, one manufacturing method used to manufacture the manifold plate 12 is injection molding. When an injection molding process is used to make the manifold plate 12, the creation of the plenums with significant depth requires no additional processes or cost. Therefore, integrating the plenums into the manifold plate 12 is useful to the manufacturing process. If the manifold plate 12 were manufactured with semiconductor techniques or machined from a solid piece of material, the creation of relatively deep plenums would require an additional process step. Various preferred embodiments utilize plenums on the micro fluidic plate having the same depth as the channels. This configuration requires only one process step for all of the manufacturing methods, and does require additional plenums on the manifold plate 12. Because the depth of the plenums on the micro fluidic plate 13 are relatively small they do not provide a large enough volume to create even pressure at the channels. The choice of location of the plenums is an engineering decision made according to the requirements of a given application.

The choices for manufacturing the micro fluidic plate 13 are the same as for the manifold plate—injection molding, semiconductor processing, and machining. For micro fluidic plates with relatively large features, typically 75 microns and above, any of the above-mentioned manufacturing methods could be deployed. For features smaller than 75 microns, injection molding or semiconductor processing would likely be the more suitable choices. For even smaller features, less than 10 microns, semiconductor processing would likely be the manufacturing method of choice. When semiconductor processing is deployed, it is desirable to have all of the features at a single depth. This is because the features are fabricated by etching and all of the features etch at about the same rate. Therefore, creating two depths of features requires twice as many processing steps as an embodiment with features of only one depth. It is therefore readily understood why in most preferred embodiments, all of the features on the micro fluidic plate 13 are the same depth. The features may have, by way of example, a depth of 20 microns.

Referring again now to FIG. 8, the micro one channels 40 join micro two channels 42 at right angles. Directly in line with the micro one channels 40 are emulsification channels 43. These channels form a “T” type junction, identified in FIG. 8 as emulsification junctions 45. Fluids one and two flow together at the emulsification junctions 45. Because fluids one and two are immiscible, droplets are formed at the junctions 45. The surface properties and the type of materials used as fluids one and two will determine whether fluid one or fluid two forms the droplets. One skilled in the art of emulsification junctions could envision many types of applicable surface properties, various fluids, and multiple channel geometries to generate the desired droplet formation.

Each micro two channel 42 is supplied by a round pad 46. For ease of manufacturing, the round pad 46 is the same depth as the other features on the micro fluidic plate 13. The round pad 46 is supplied by the feedthroughs 25 on the manifold plate 12. Each round pad 46 supplies an intermediate channel 47 that in turn supplies two micro two channels 42. An example of an alternate configuration would be to supply both micro two channels 42 directly from the round pad 46.

The emulsification channels 43 deliver the emulsification generated at the emulsification junction 45 to the outlet plenum 36. The outlet plenum 36 has similar design criteria as the other plenums. Referring back to FIG. 4, the outlet channel 35 in the manifold plate 12 connects to the outlet port 16. As discussed above, the plenums could reside in one or both of the plates, either the micro fluidic plate 13 or the manifold plate 12. This same option applies to the channels. Manufacturing methods selected by the user would determine the location of the channels and plenums. If the manifold plate was to be injection molded, one might not want to include the micro or emulsification channels due to less dimensional accuracy. These channels are critical to the production of the emulsification. Injection molding does not provide as much accuracy and consistency as semiconductor processing techniques. One exception to the limitations of injection molding is when a DVD/CD type molding machine is used. Tooling for these types or machines is created with semiconductor processes and therefore can provide very small, accurate features.

In most instances, it is desirable to have an emulsion with consistent droplet size. Accurate control of the dimensions of the channels near the emulsification area has the most significant effect on consistent droplet size. Ideally, all of the cross-sectional areas of the channels for a particular device are as close to identical as possible.

The second most significant factor for consistent droplet size is consistent flow to and from the emulsification area. Having a relatively large plenum ensures that the channels delivering fluids to the emulsification area are delivered at the same rate. Further, variation in the dimensions of like channels will create variation in the flow to the emulsification areas. Accurate dimensional control of the channels ensures consistent flow.

The viscosity and the surface tension of the fluids used in the emulsification also have an impact on droplet size. By processing the fluids with one device other factors that affect consistency are easier to control. For example, temperature, one factor that typically affects viscosity, which in turns affects droplet size, can be kept consistent in the emulsification device. This is possible because in all of the emulsification areas, the fluids only flow a short distance from the main flow stream until they reach the emulsification areas. The device by its nature is inherently isothermal.

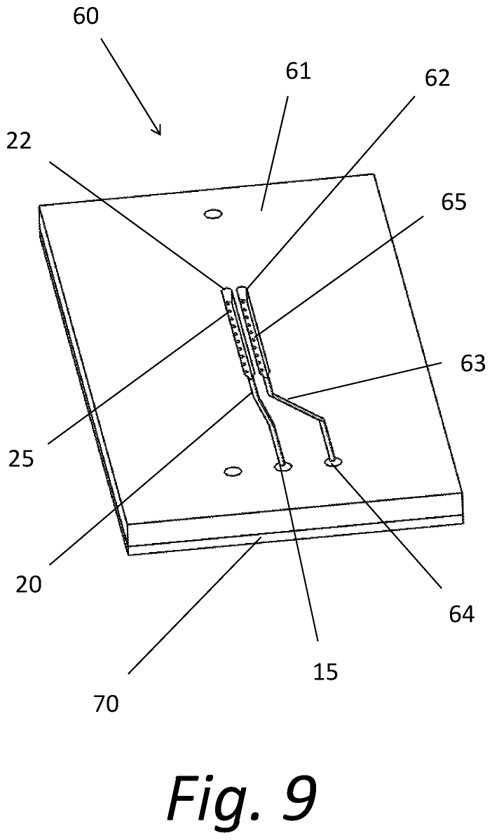

FIG. 9 illustrates an alternate embodiment of the invention. In embodiments of this nature, the device has a cover similar to the preferred embodiment shown in FIG. 1. One modification is that the cover would include an additional fluid port to accommodate the introduction of a third fluid, fluid three inlet port 64. (The cover is not shown in FIG. 9 for clarity.) The device 60 shown in FIG. 9 can be referred to as a double emulsification device, which creates a “double” emulsification. As described herein, a double emulsification device generates droplets that have an internal droplet or droplets of a third immiscible fluid. An example of such double emulsifications are essentially droplets within droplets. The basic structure of a water-based double emulsification droplet is fluid one within an oil-based droplet, fluid two suspended in another water-based fluid, and both suspended in fluid three. Fluid three would be introduced in a like manner as fluid two. Fluid three would be delivered to the fluid three plenum 62 from the fluid three channel 63 that is supplied by the fluid three inlet port 64. The fluid three plenum 62 supplies fluid three feedthrough holes 65.

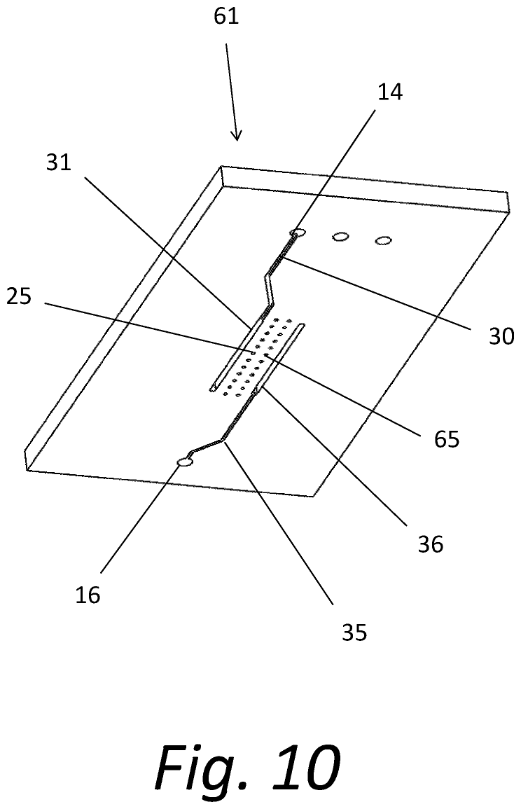

A third fluid plenum 62 and the feedthrough holes 25 that supply the double micro plate 70 are positioned similarly to those elements in the preferred embodiment. As illustrated in FIG. 10, showing a bottom of the double manifold plate 61, an added element is the fluid three feedthrough holes 65. As with the preferred embodiment, the plenums and feedthroughs mate to the double micro plate 70.

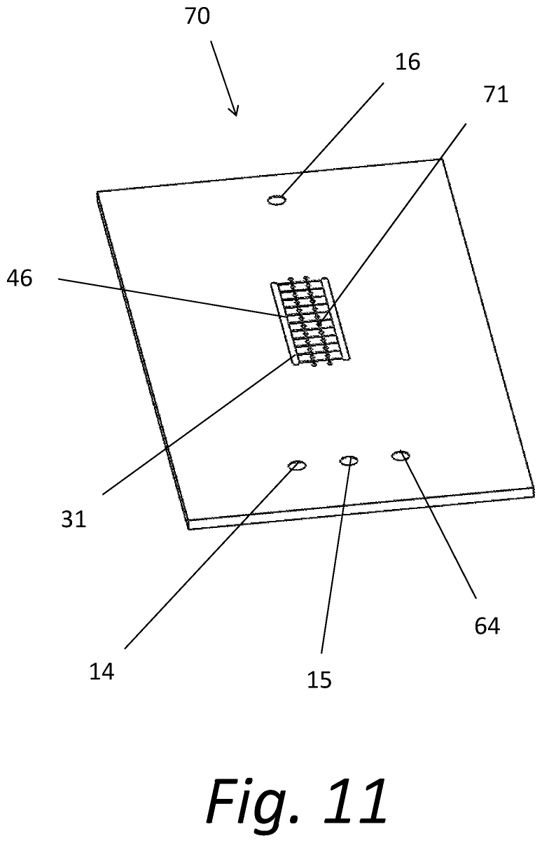

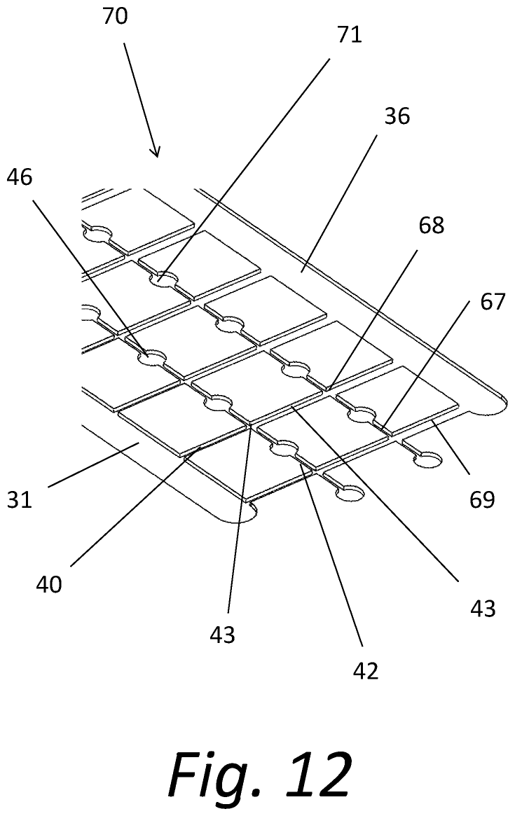

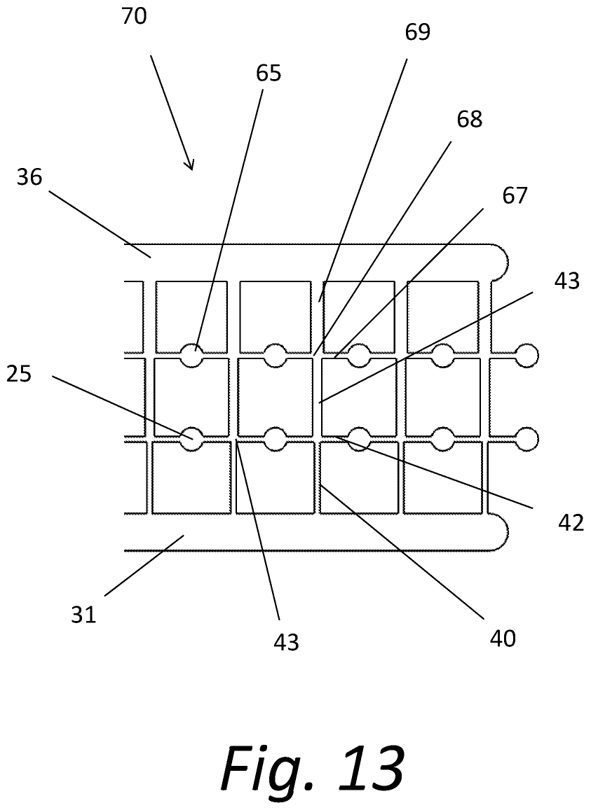

FIG. 11 is a top view of a double micro plate 70. FIGS. 12 and 13 show detail views of the features shown in FIG. 11. The fluid emulsification junctions are supplied with fluid one and fluid two by micro one channel 40 and micro two channel 42 to create a single emulsification. The single emulsification is delivered to double emulsification junctions 68 via the emulsification channels 43. The double emulsification is created at the double emulsification junctions 68 where micro three channels 67 deliver fluid three and is joined with a first emulsification to form the double emulsification. The micro three channels 67 are supplied by the fluid three feedthroughs 65. The double emulsification is then delivered to the outlet plenum 36 via double emulsification channels 69.

It should be noted that in the embodiments shown in FIGS. 9-12, fluids two and three are delivered from both sides of the emulsification area. This technique can be deployed in most of the embodiments described herein. The resultant double emulsification is delivered to the outlet port to exit the device.

As mentioned above, the surface properties of the channel materials and the types of fluids used determine if the droplets are formed from fluid one or fluid two. For a double emulsification process, the surface properties of some of the channels might need to be different than others. In one example, fluid one being a water-based fluid and fluid two being an oil-based fluid, the preferred channel surface would be oleophilic and hydrophobic. The surface properties of the channels might need to be modified in the area where the double emulsification is formed. One skilled in the art would be able to modify the properties in order to create the desired emulsification products.

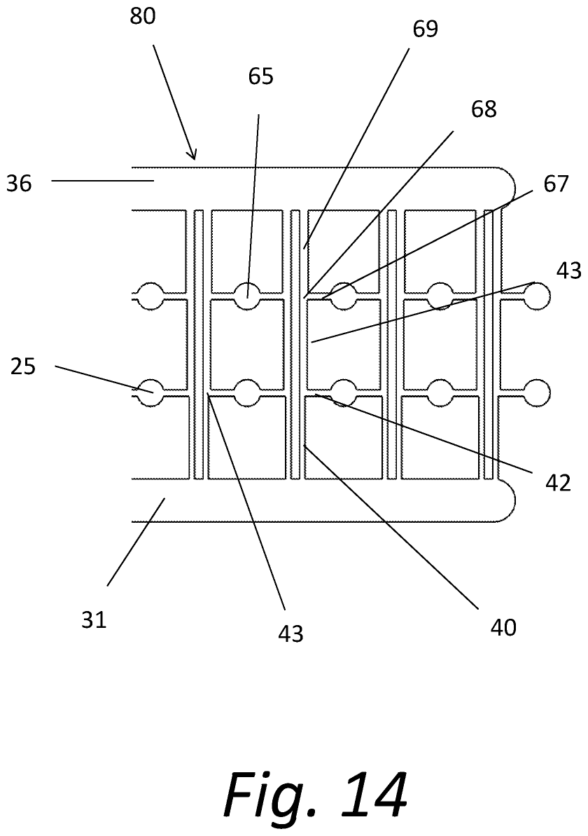

FIG. 14 shows an alternative configuration for the emulsification areas. In this configuration, the emulsification areas are supplied from only one direction rather than from both sides.

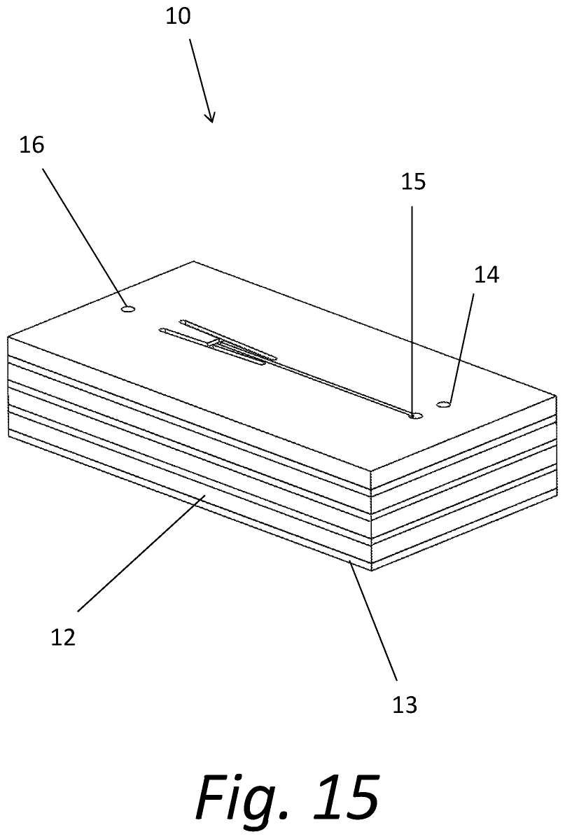

FIG. 15 illustrates a vertically arrayed configuration including multiple emulsification layers. As with other configurations described herein, a required top cover is not shown for clarity. By stacking alternating manifold plates and micro fluidic plates, greater production capacity is provided by the device 10. The ports in the micro fluidic plates would need to be through holes rather than counterbored holes to allow fluid flow between the multiple plates.

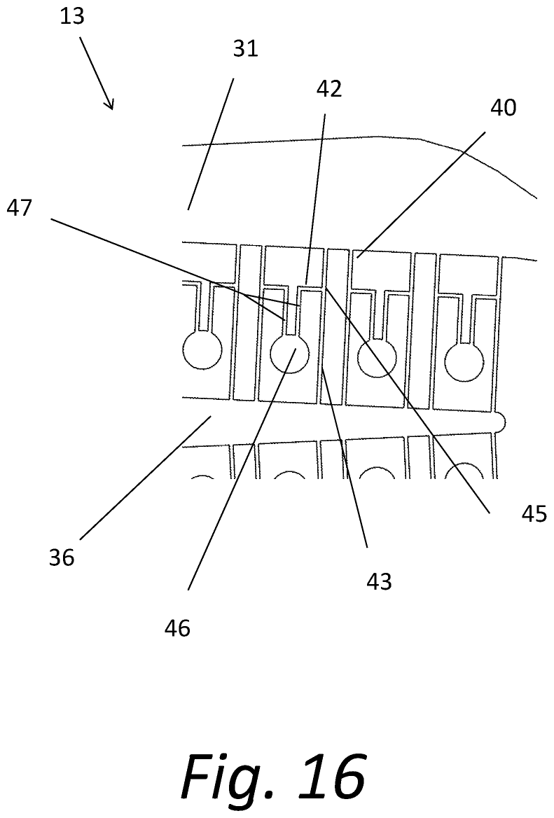

In embodiments such as those shown in FIG. 16, the intermediate channels 46 are modified slightly. Two intermediate channels 46 flow from each round pad 46 so that each emulsification junction 45 has a dedicated feed, intermediate channel 46.

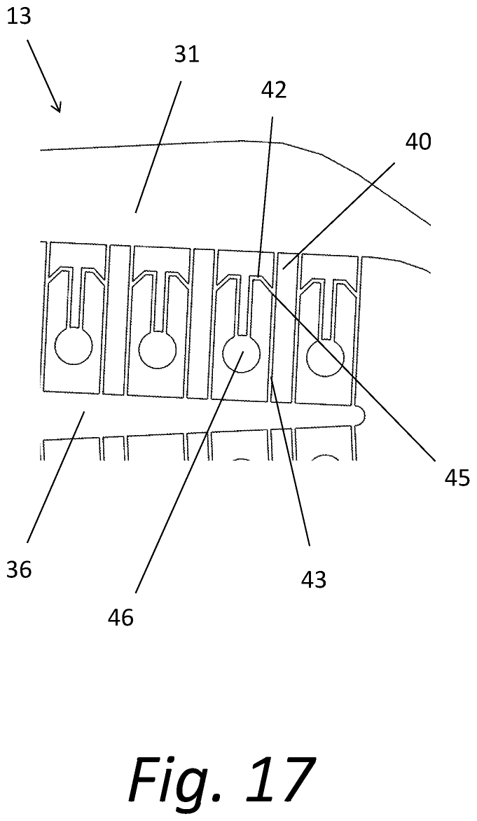

FIG. 17 shows another possible modification of the emulsification areas. In embodiments of this nature, the emulsification junction 45 is positioned in a “Y” configuration rather than a “T” shaped junction.

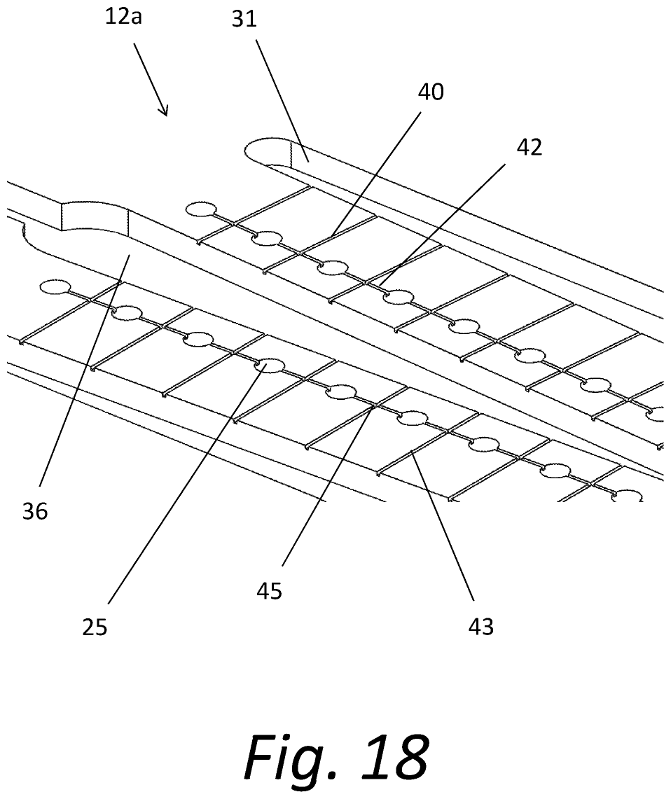

FIG. 18 shows yet another possible modification of the emulsification areas. In this configuration, the emulsification junction 45 and channels 40, 42, 43 are located on a modified manifold plate 12-a rather than the micro fluidic plate 13. The plate that mates with this manifold plate 12-a could have a flat surface to enclose the channels on the modified manifold plate 12-a.

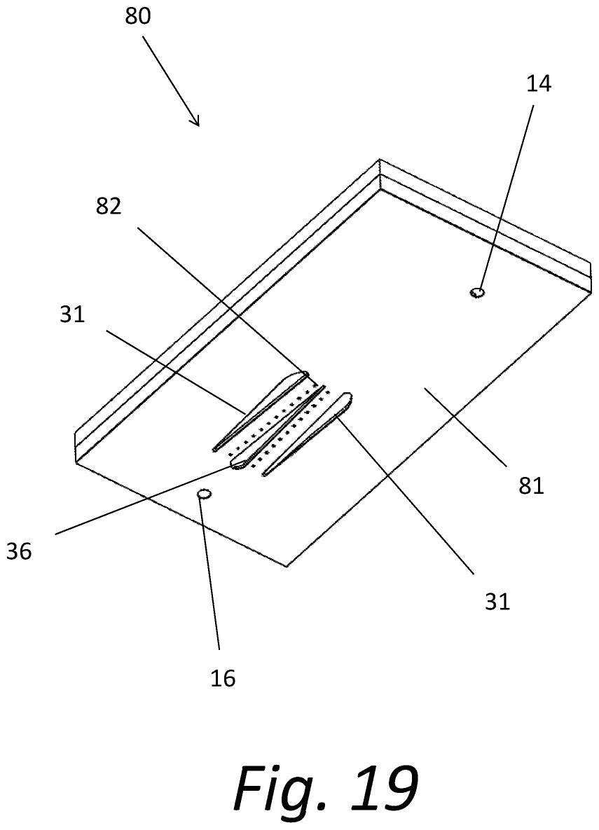

FIG. 19 shows another modification in which an additional plate is utilized in an emulsification device 80. In this configuration an aperture plate 81 is employed in the emulsification device 80. In some manufacturing processes, the size of the feedthrough holes 25 in the manifold plate 12 is limited by the selected process. Smaller holes allow for a more compact emulsification device 80. By adding the aperture plate 81, smaller feedthrough holes 82 can be provided than would otherwise be possible. The aperture plate 81 is fabricated with thin material. Smaller holes can be punched or etched in the thin aperture plate 81 than could be molded in the relatively thick manifold plate 12. Closer spacing of the small feedthrough holes 82 allows for more channels and more emulsification in a given volume of the device.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the Figures are merely schematic representations of the present disclosure. As such, some of the components may have been distorted from their actual scale for pictorial clarity.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various Figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. An emulsification device, comprising:
at least one inlet plenum and at least one outlet plenum;
a plurality of feedthrough holes defining a fluid flow path between a first fluid inlet plenum and at least one fluid one channel, the plurality of through holes further defining a fluid flow path between a second fluid inlet plenum and at least one fluid two channel;
the fluid one channels and the fluid two channels being in fluid communication with junctions at which emulsification droplets are formed.

2. The emulsification device of claim 1, wherein:
the device further comprises a first plate comprising features on a bottom side, the features defining a first side of the at least one first fluid inlet plenum;
a second plate mated on a first side to the first plate, a first side of the second plate comprising features defining a second side of the at least one first fluid inlet plenum, a second side of the second plate comprising features defining at least a first side of at least one second fluid inlet plenum, a second side of the second plate comprising further features defining at least one side of the fluid one channels and the fluid two channels,
a third plate with a first side mated to the second side of the second plate, the first side of the third plate comprising features that define a second side of the fluid one channels and the fluid two channels.

2. The device according to claim 1, wherein the second side of the of the second plate comprises features forming at least one side of an outlet plenum.

3. The device according to claim 2, wherein the top side of the third plate comprises features forming at least one side of the outlet plenum.

4. The device according to claim 1, wherein the feedthrough holes provide a fluid flow path from the inlet plenum to a fluid flow path of a second fluid, thereby allowing the two fluids to combine to form an emulsification.

5. The device according to claim 4, wherein the feedthrough holes deliver the emulsification to an outlet plenum.

6. The device according to claim 1, wherein:
the junctions are T shaped.

7. The device according to claim 1, wherein:
the junctions are Y shaped.

8. The device according to claim 1, wherein:
the device comprises an aperture plate with the through holes formed therein.

9. An emulsification device, comprising:
a first plate comprising features on a bottom side, the features defining a first side of at least one plenum for a first fluid;
a second plate mated on a first side to the first plate, the first side of the second plate comprising features defining a second side of the at least one plenum;
feedthrough holes providing a fluid flow path from the plenum to a second side of the second plate, the second side of the second plate comprising features defining at least a first side of at least one plenum for a second fluid, a second side of the second plate comprising further features defining at least one side of channels forming a fluid flow path that joins the two fluids to create an emulsification; and
a third plate with a first side mated to the second side of the second plate, the first side of the third plate comprising features that define a second side of the channels forming a fluid flow path.

10. The device according to claim 9, wherein the bottom side of the of the second plate comprises features forming at least one side of an outlet plenum.

11. The device according to claim 10, wherein the top side of the third plate comprises features forming at least one side of an outlet plenum.

12. The device according to claim 9, wherein the feedthrough holes provide a fluid flow path from the plenum to a fluid flow path of a second fluid, thereby allowing the two fluids to combine at junctions in the fluid flow path at which emulsification droplets are formed.

13. The device according to claim 12, wherein the feedthrough holes deliver the emulsification droplets to an outlet plenum.

14. The device according to claim 12, wherein:
the junctions are T shaped.

15. The device according to claim 12, wherein:
the junctions are Y shaped.

16. The device according to claim 12, wherein:
the device comprises an aperture plate with the through holes formed therein.
